(19) United States
(12) Patent Application Publication
(10) Pub. No.: US 2003/0040973 A1
(43) Pub. Date: Feb. 27, 2003

(54) Multi-level remote order entry system and method

(75) Inventor: Laurence Victor Marks, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/938,962

(22) Filed: Aug. 24, 2001

(51) Int. Cl. G06F 17/60

(52) U.S. Cl. 705/26; 705/30

(57) ABSTRACT

A merchandise order entry system is provided with a multi level order entry screen. The screen includes one or more profile fields each of which can have different order parameters such as different credit card numbers, and bill to and ship to addresses. A remote user can, in addition to entering orders, edit, delete or create profile fields.

### FIELD OF THE INVENTION

The invention relates to a multi-level remote entry system and method which is suitable for use as a remote order entry system in which a user located at a remote computer connected via the Internet to a central data base has access to multiple sets of order entry parameters.

### BACKGROUND

Transactions on the World Wide Web use Hyper Text Transfer Protocol (HTTP) which is stateless. That is, when a user visits a web page and then proceeds to a succeeding page by clicking a link, the server has no knowledge of where the user came from; whether he clicked a link on another page on that server, clicked a link on another server, clicked a bookmark link, or typed in a link he saw in the newspaper. Certain kinds of transactions require some knowledge of state however. One of these is electronic purchase. There are at least two methods of enhancing HTTP to maintain state.

One method is to attach relevant information to the end of each link. When the user selects the link, the information is also delivered. For example, the URL: http://www.foobar.com/widgets.html?buyer=lvmarks&customer=preferred would send a request to the wwwtfoobar.com server requesting the page widgets.html and passing two state variables/value pairs, buyer=lvmarks and customer=preferred. An elaboration of this scheme appears in U.S. Pat. No. 5,961,601 to Iyengar.

A second method is the use of cookies, attribute value pairs stored on the user's computer and delivered to the server (web site) with the user's request. This sort of authentication mechanism is disclosed in U.S. Pat. No. 5,560,008 to Johnson et al. Cookies are described in RFC-2109, HTTP State Management Mechanism. A server can place cookies on a client's computer by including the appropriate command in an HTTP data stream. For example, the stream Set-Cookie:buyer=lvmarks;customer=preferred;Version=1 sent by the server www.foobar.com would store the two state variable/value pairs buyer=lvmarks and customer=preferred, along with the domain www.foobar.com.

The buyer's browser would preface all subsequent requests to www.foobar.com with Cookie: SVersion=1;buyer=L V Marks;customer=preferred which the server may use to keep track of transaction state. A server can also delete a cookie on the client's browser, by sending a new cookie with the same name and a Max-Age of zero.

A passive web server responds to HTTP GET requests for static pages by delivering static text and graphic content. An interactive web server, such as is used in e-commerce, interacts with a program or programs to dynamically create and deliver web pages resulting from user requests. One interface between the web server and processing programs is called the Common Gateway Interface or cgi. Programs that receive requests from a web browser, forwarded by a web server, and deliver answers to the server for delivery to the browser are often called cgi scripts.

The CGI specifications are maintained by NCSA.

An Internet shopping experience generally begins with presentation of merchandise available for purchase: an electronic catalog. If the shopper has never made purchases at the website before, the web page will appear in a web browser as depicted in FIG. 1. If the shopper has made purchases at the web site before, his computer will contain a cookie. In that case, the web page might have an additional, personalized message, for example, “Welcome back, L V Marks!” derived from the buyer variable value in the stored cookie. In FIG. 1, the user has the option to view widgets or gadgets in the catalog, or to check out (make an electronic purchase). (The web server cgi scripts may be used to access a database server which is used to store purchaser information and perhaps to relate a customer name or number to a greeting name.)

If the buyer elects to view widgets, he is shown a web page like FIG. 2. He can elect to purchase various widget models, by selecting the “Add to shopping cart” button. Each purchase causes the server to send an additional merchandise cookie to the buyer. When the buyer has completed his shopping, he selects the Check Out option. If no buyer cookie is delivered to the server when this selection is made, the server concludes that the shopper has not made purchases at this website before, and the shopper is presented with a screen like FIG. 3. The user completes this screen as shown in FIG. 4 (except that the user would enter a complete credit card number), and submits it, whereupon he is presented with a screen like that in FIG. 5.

If a valid buyer cookie is delivered to the server when electing to check out (FIG. 2), the buyer is presented with a screen like that in FIG. 5. When a screen like FIG. 5 is presented, all the merchandise cookies are deleted from the client and a new cookie is added, containing a single order number which is used to track the order.

The user can modify the order or commit it. If he commits it (by selecting the “Continue” button, the order is accepted, and the user's credit card is charged, and FIG. 6 is presented. This screen might also include such things as an order confirmation number or shipment tracking number. When this screen is presented, the order number cookie is deleted from the client machine. (The web server may access a database to which it is coupled to get the information presented in FIG. 6.)

A long-standing problem with this sequence is that the purchaser cannot determine what shipping and billing and addresses are to be used with an order, nor which credit card is to be charged. If the information is incorrect, the user will be surprised and have to take additional steps to correct or cancel the order.

In some cases, the information shown on FIG. 6 might be shown before FIG. 5. The user will not place an incorrect order in this case, but will find himself forced to delete and re-enter information that has changed. In some cases, where the new information is temporary (sending a gift for example), the user will have to re-enter the normal information later. The buyer may get around this problem by creating multiple accounts at each on-line merchant, but this has its own difficulties. The user must keep track of which account is which, and he will be unable to group his purchases to take advantage of volume discounts or rebates.

### SUMMARY OF THE INVENTION

The invention contemplates a remote order entry system which includes multiple sets of user information at the server, and allows a remote user to modify the information included in any set, establish new sets of user information and to select one of the sets to be used at each transaction.

The information sets may include at least:

Sets of accounting information with different credit card information, to disperse charges

Sets of accounting information with multiple different ship-to addresses, to send gifts

Sets of accounting information with different credit card information, bill-to, and ship-to information, distinguishing items bought for personal use from items bought in the course of employment

It is therefore an object of this invention to display to the purchaser all the account information sets on file at the vendor.

It is a further object of this invention to permit the purchaser to select one of the account information sets for a given purchase.

It is yet a further object of the invention to permit the purchaser to add additional account information sets.

It is yet a further object of the invention to permit the purchaser to edit a selected account information set.

It is yet a further object of the invention to permit the purchaser to delete a selected account information set.

### BRIEF DESCRIPTION OF THE DRAWINGS

FIGS. 1-6 are graphic representation of user screens utilized in prior art remote order entry systems;

FIG. 7 is a graphic representation of a user screen arranged according to the present invention;

FIG. 8 is a table listing the HTML for buttons illustrated in FIG. 7;

FIGS. 9 and 10 are flow charts illustrating a software implementation of the invention; and,

FIG. 11 is a block diagram illustrating a system in which the invention is used.

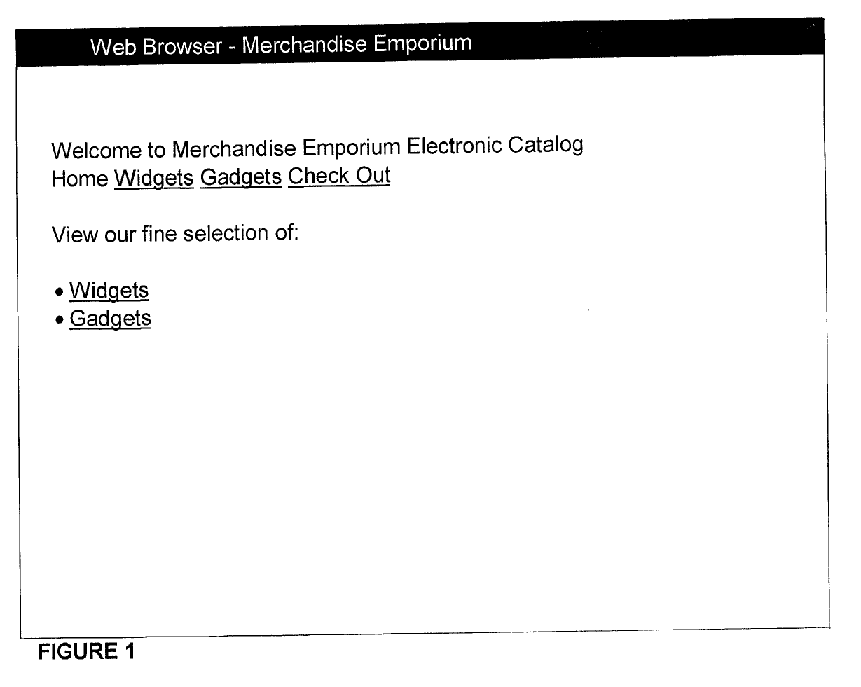

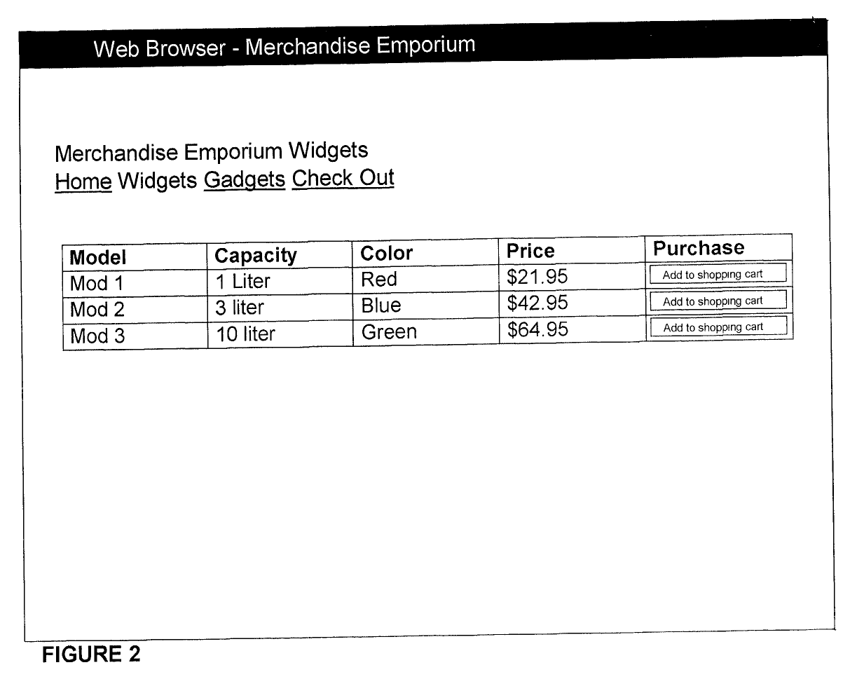

### DETAILED DESCRIPTION OF THE INVENTION

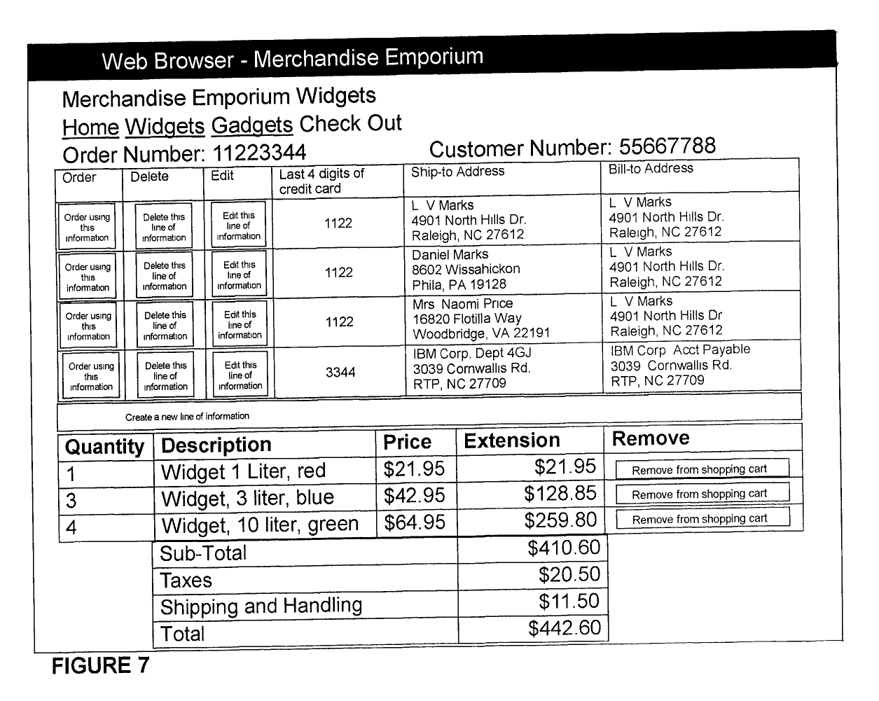

The shopping improvement provided by this invention is shown in FIG. 7. Before the customer's order is committed, he is shown a set of ordering information or profile fields he has previously used. This information is stored in a database coupled to the web server in a manner apparent to those with skill in the art. For example, see U.S. Pat. No. 5,715,453 to Stewart, U.S. Pat. No. 5,737,592 to Nguyen et al. and U.S. Pat. No. 6,105,043 to Francisco et al.

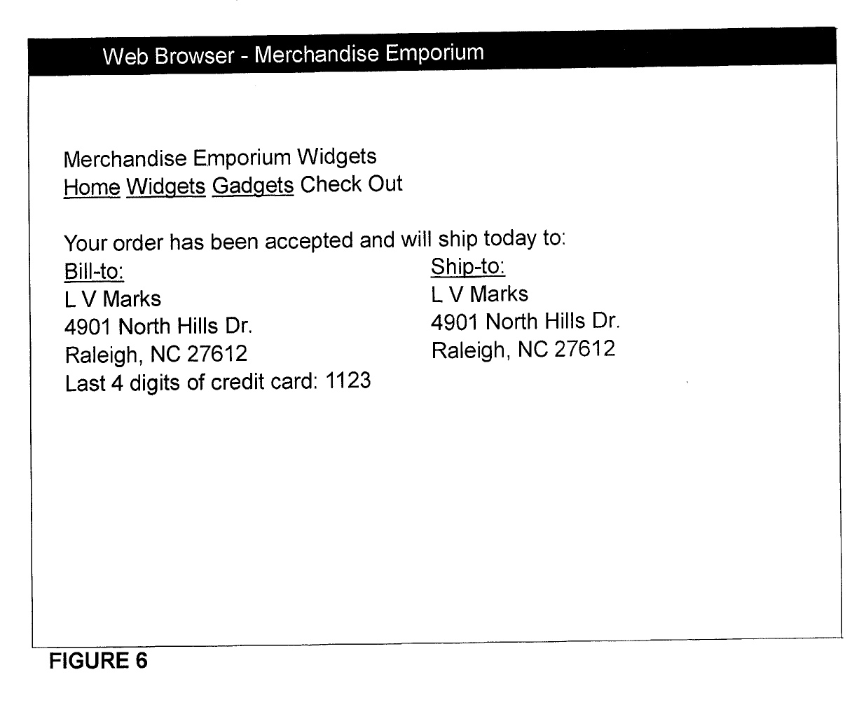

The user may immediately commit his order using a selected one of the stored records containing credit card number and shipping and billing addresses by selecting one of the “Order using this information” buttons, in which case a screen like that shown in FIG. 6 is shown next. Cookies are updated as in the prior art.

Or the user may elect to modify the stored records or profile fields. He may delete any stored record by selecting the appropriate “Delete this line of information” button, in which case the database is updated and the user is next shown an updated version of the screen in FIG. 7.

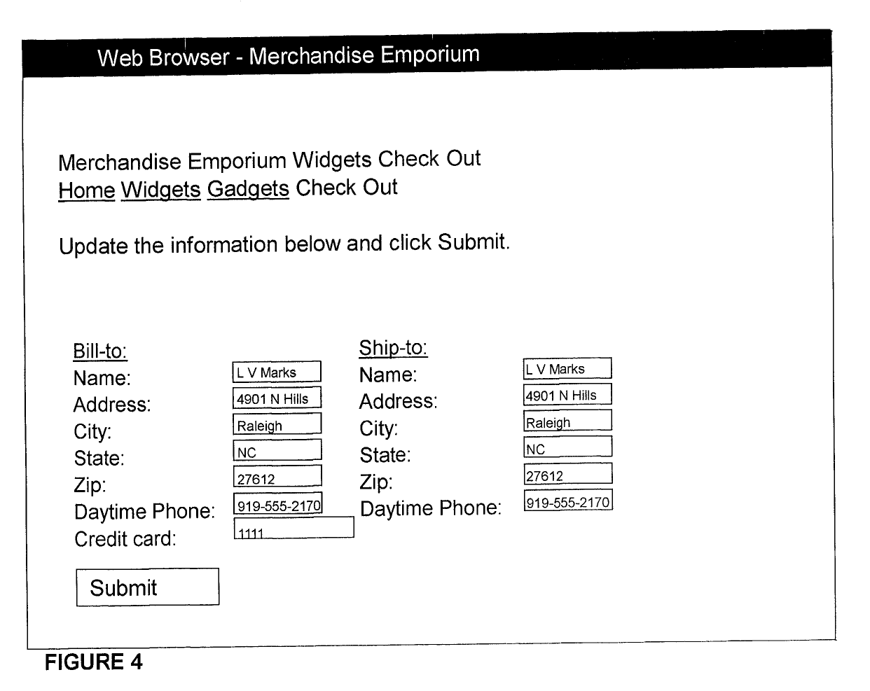

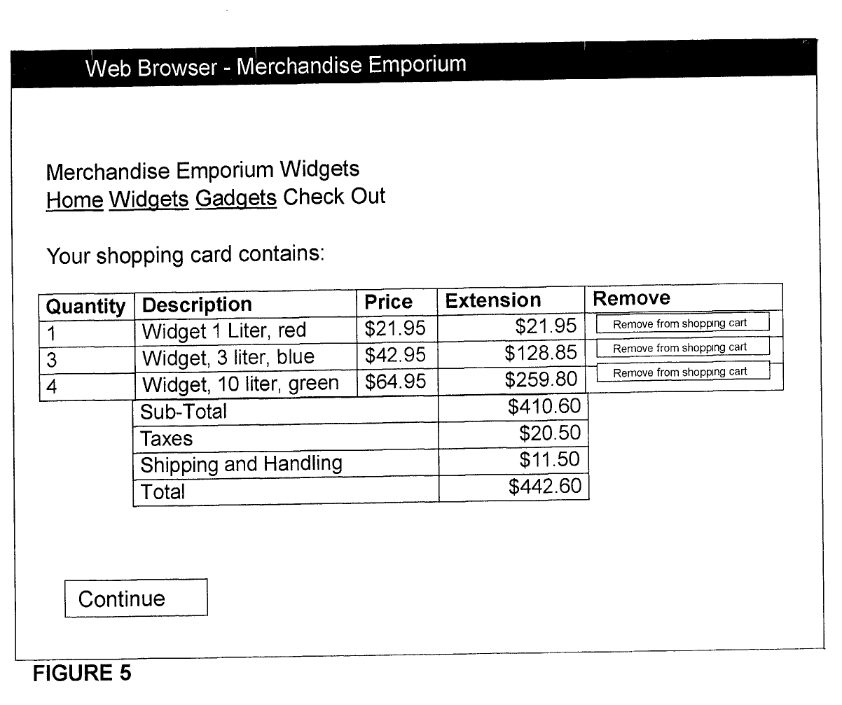

Or the user may elect to modify or edit a stored record by selecting one of the “Edit this line of information” buttons. In that case a screen like that shown in FIG. 4 is displayed, filled in with current information, except that for reasons of security only the last four digits of the user's credit card are displayed. The user modifies data as necessary. When he completes this task and selects the “Submit” button, the database is updated and the user is next shown an updated version of the screen in FIG. 7.

Or the user may elect to create a new information record or profile field, by selecting the “Create a new line of information” button. In that case a screen like that shown in FIG. 4 is displayed, not filled in. The user provides the necessary data. When he completes this task and selects the “Submit” button, the database is updated and the user is next shown an updated version of the screen in FIG. 7.

The user may also elect to delete items from the order, as in the prior art. In this case, the order associated with the order number cookie on the client's computer is updated and an updated version of the screen shown in FIG. 7 is displayed.

Although this invention is described in terms of a web-based user experience, it is by no means limited to that environment. It is equally applicable to telephone shopping and face-to-face retail or commercial transactions.

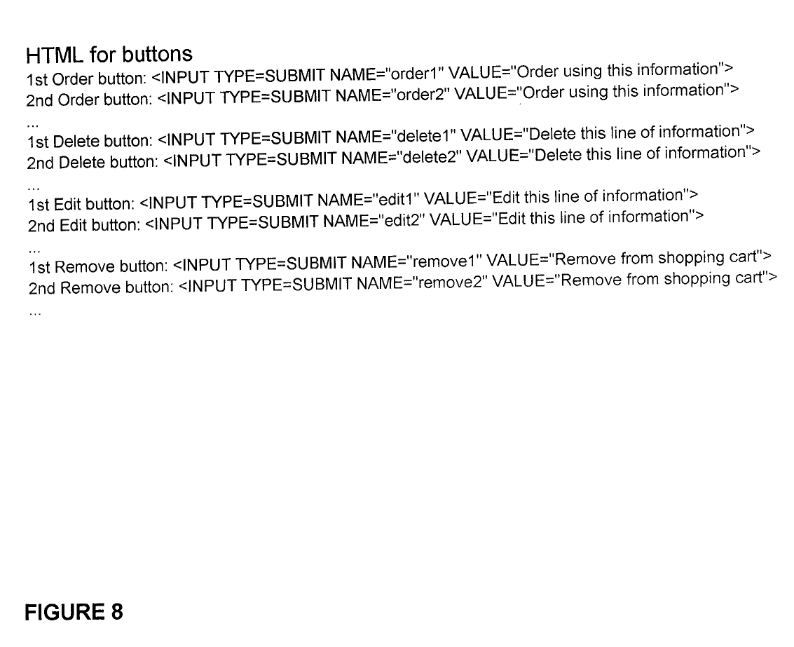

Web pages are composed in Hyper Text Markup Language (HTML) which is carried in HTTP. HTML provides means to deliver a screen with text, images, hyperlinks, and buttons. The screen of FIG. 7 contains several buttons. HTML corresponding to the first two buttons of each type is shown in FIG. 8. When the user selects, for example, the first order button, the button name (order1) is returned to the server, along with appropriate cookies. The server parses the button name into alphabetic and numeric portions. It uses the alphabetic portion to determine what action was requested and the numeric portion (if any) to determine what information record to act on.

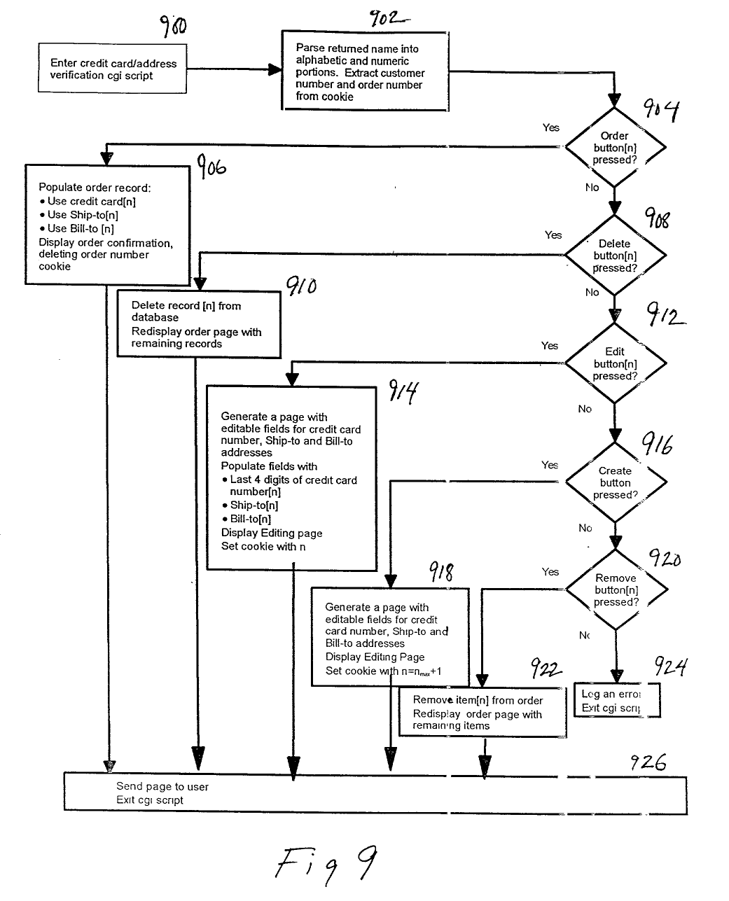

FIG. 9 is a flow chart of the processing to be performed when the user selects any button on the screen shown in FIG. 7. The chart is entered at block 900. The input argument (the name of the button that was selected) is parsed in block 902, and the alphabetic and numeric portions are separated. For example, if the second “Order” button was pressed, name=order2 is returned, and block 902 separates “order” from “2”. The extracted numeric portion will henceforth be referred to as n. Blocks 904, 908, 912, and 916 test the alphabetic part. Block 902 also extracts a cookie returned from the client containing the order number and name or customer number. Records described in subsequent steps of FIG. 9 are limited to those matching the order number and name or customer number.

Block 904 tests for the value “order”. If it is found, an order record is prepared and executed using the n-th set of address and credit card information, as shown in block 906. An order confirmation screen like that of FIG. 6 is prepared, also using the n-th set of address and credit card information. Control transfers to block 926 which delivers the page to the web server for transfer to the user, and then exits the script.

If the name returned was not “order”, control transfers to block 908, where the name is compared to “delete”. If it matches, control transfers to block 906 and the n-th set of address and credit card data is deleted from the data base, and a screen like that of FIG. 7 is prepared for the buyer. This will look similar to the screen he was viewing, except that one line of address and credit card data will have been deleted. Control transfers to block 926 which delivers the page to the web server for transfer to the user, and then exits the script.

If the name returned was not “delete”, control transfers to block 912, where the name is compared to “edit”. If it matches, control transfers to block 914 and a screen similar to FIG. 4 is prepared, prepopulated with information from record n; that is, shipping and billing addresses from record n as well as the last four digits of the credit card associated with record n. (For security reasons the entire credit card number is never sent from the server to the client.) An additional cookie is set, containing n, the number of the record to be edited. Control transfers to block 926 which delivers the page to the web server for transfer to the user, and then exits the script.

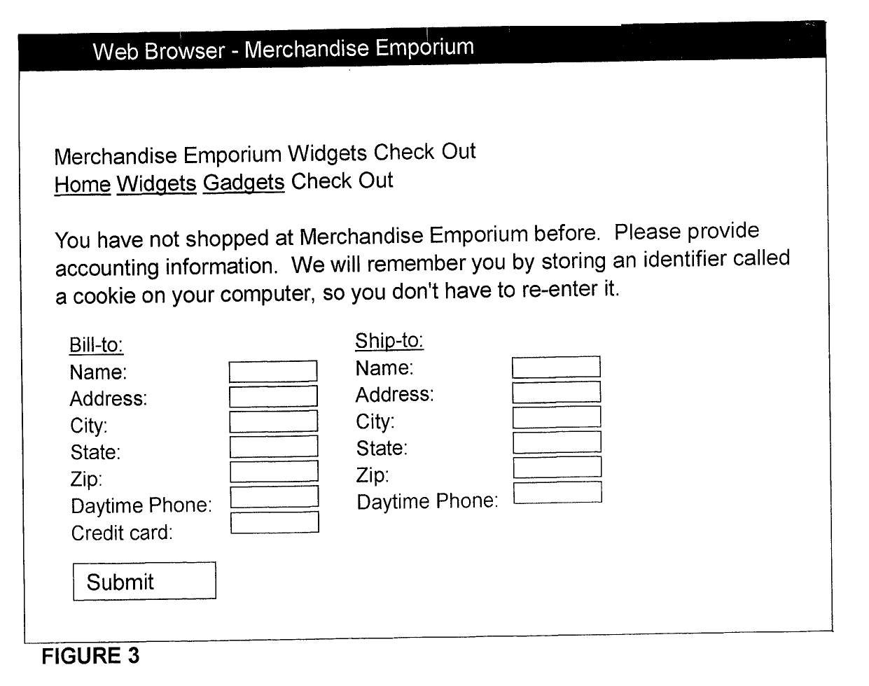

If the name returned was not “edit”, control transfers to block 916, where the name is compared to “create”. If it matches, control transfers to block 918 and a screen similar to FIG. 3 is prepared, but not prepopulated. An additional cookie is set, containing n, a value one greater than the number of stored records for the user. Control transfers to block 926 which delivers the page to the web server for transfer to the user, and then exits the script.

If the name returned was not “edit”, control transfers to block 920, where the name is compared to “remove”. If it matches, control transfers to block 922, the n-th set of items is deleted from order, and a screen like that of FIG. 7 is prepared for the buyer. This will look similar to the screen he was viewing, except that one line of address and credit card data will have been deleted. Control transfers to block 926 which delivers the page to the web server for transfer to the user, and then exits the script. If the name returned was not “remove”, control transfers to block 924. Control should never reach this point, so an error is logged, with all relevant information, including time of day, server state, and all relevant cookies, customer number, and the erroneous name returned with the request. The script is exited. Nothing is changed at the buyer's computer, so he can re-try the operation by making any selection.

Two of the operations, edit and create, cause a form similar to FIG. 4 to be displayed at the user's computer. In the case where edit was selected, portions of the form are pre-populated. When the user submits the form, cookies containing his name or customer number and order number are returned to the server. The order number isn't relevant, but the name or customer number are used to assure that the right customer records are updated in the database.

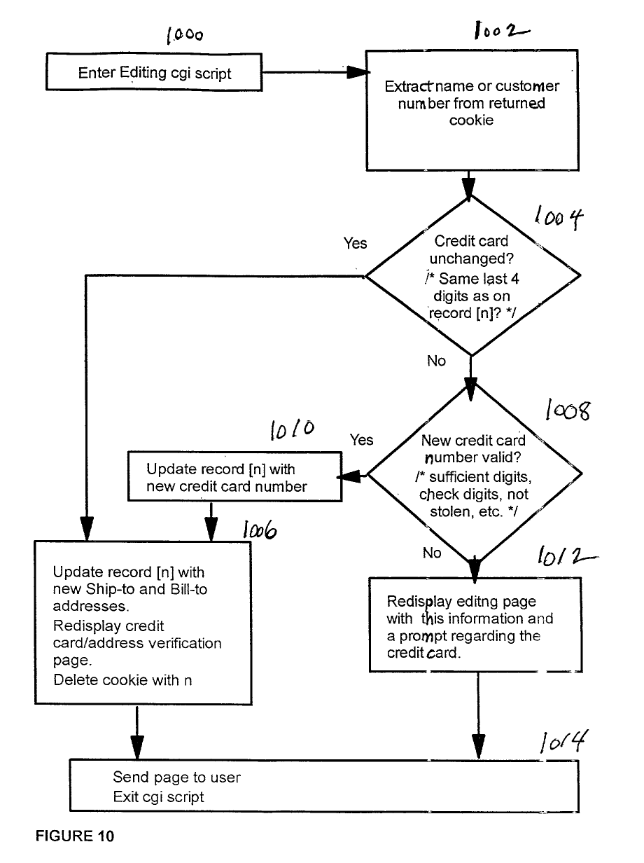

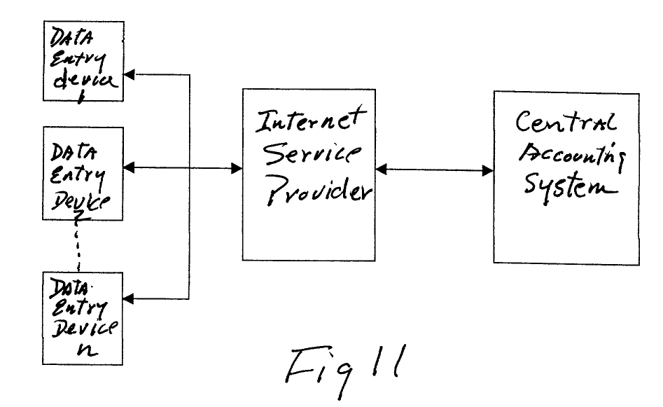

FIG. 10 is a flow chart depicting processing that occurs when the user completes the form shown in FIG. 3 or FIG. 4 and submits it. The chart is entered at block 1000. In block 1002, the buyer's name or customer number is extracted from the returned cookie as is n, the number of the record to be modified. Records described in subsequent steps of the flow chart of FIG. 10 are limited to those that match the value extracted from the cookie.

In block 1004, the value returned for the credit card number is tested. If it is four digits long, and matches the last four digits of the credit number already stored in the user's record n, the user did not update the credit card number field, so it is unchanged. (It would be incorrect to replace the stored complete credit card number with only the last four digits.) Control transfers to block 1006 where all the other fields in the billing and shipping address of record n are updated. A page similar to FIG. 7 is prepared using the updated buyer information. The cookie containing the value n is deleted. Control transfers to block 1014 which delivers the page to the web server for transfer to the user, and then exits the script.

If a change in the credit card field was detected (the value returned for the credit card does not match the last four digits stored in the buyer's record n), control transfers to block 1008 where the credit card is validated via the usual means (checksum, not stolen, not over limit, etc.). If the card is valid, control transfers to block 1010 where the new credit card information is stored in the buyer's record n. Control transfers to block 1006 where all the other fields in the billing and shipping address of record n are updated. A page similar to FIG. 7 is prepared using the updated buyer information. The cookie containing the value n is deleted. Control transfers to block 1014 which delivers the page to the web server for transfer to the user, and then exits the script.

If the credit card proves to be invalid in the test at block 1008, control transfers to block 1012 and a screen similar to FIG. 4 is redisplayed, with an added prompt indicating the credit card problem. The cookie containing the value n is not deleted. Control transfers to block 1014 which delivers the page to the web server for transfer to the user, and then exits the script.

While the invention is susceptible to various modifications and alternative forms, specific embodiments have been shown or described in detail by way of example. It should be obvious to those skilled in the art to which the invention pertains that the invention is not limited to the specific embodiments described and illustrated, but on the contrary, the invention is intended to cover all alternatives, modifications and equivalents falling within the spirit and scope of the invention as defined by the claims.

I claim:

1. In a data entry system which includes a central accounting system, a plurality of user controlled data entry means and a communication system for connecting the data entry means to the central accounting system a method for generating, in response to a request from a user at a data entry means, a control screen for display at the data entry means including the steps:
storing in memory data for defining a control screen which includes
at least one profile field which includes a plurality of parameters unique to the user,
a field for indicating, when selected by the user, the need to create an additional profile field containing different parameters unique to the requesting user; and,
generating and transmitting the generated control screen to the data entry means via the communication system.

2. The method set forth in claim 1 including the steps:
in response to a request from the user for an additional profile field, generating and transmitting a parameter entry input screen suitable for transmission over the communication network to the requesting user.

3. The method set forth in claim 2 including the steps:
in response to the receipt of a completed parameter entry input screen from the user updating the stored data defining the control screen associated with the user; and,
generating a control screen using the updated stored data and transmitting the updated control screen over the communication system to the user located at the data entry means.

4. In a merchandise order entry system which includes a central accounting system, a plurality of user controlled order entry means and a communication system for connecting the user controlled order entry means to the central accounting system a method for generating, in response to a request from a user at an order entry means, a control screen for display at the order entry means including the steps:
storing in memory data for defining a control screen which includes
at least one profile field which includes a plurality of parameters unique to the user, and
a field for indicating, when selected by the user, the need to create an additional profile field containing different parameters unique to the requesting user; and,
generating and transmitting the generated control screen to the order entry means via the communication system.

5. The method set forth in claim 4 including the steps:
in response to a request from the user for an additional profile field, generating and transmitting a parameter entry input screen suitable for transmission over the communication network to the requesting user.

6. The method set forth in claim 5 including the steps:
in response to the receipt of a completed parameter entry input screen from the user updating the stored data defining the control screen associated with the user; and,
generating a control screen using the updated stored data and transmitting the updated control screen over the communication system to the user located at the order entry means.

7. The method set forth in any one of claims 4-6 in which the said at lest one profile field includes a plurality of user selectable sub-fields each of which when selected by the user defines a unique action.

8. The method set forth in claim 7 in which the user selectable sub-fields include a first sub-field for requesting an order entry, a second user selectable sub-field requesting an edit of the unique parameters and a third user selectable sub-field requesting deletion of the profile field.

9. The method set forth in claim 8 in which the unique parameters in the profile field include a credit card number sub-field, a ship to address sub-field and a bill to address sub-field.

10. In a merchandise order entry system which includes a central accounting system, a plurality of user controlled order entry means and a communication system for connecting the user controlled order entry means to the central accounting system apparatus for generating, in response to a request from a user at an order entry means, a control screen for display at the order entry means including:
means for storing in memory data for defining a control screen which includes
at least one profile field which includes a plurality of parameters unique to the user, and
a field for indicating, when selected by the user, the need to create an additional profile field containing different parameters unique to the requesting user; and,
means response to a request from a user at an order entry means for accessing the stored data defining the control screen and generating and transmitting the generated control screen to the order entry means via the communication system.

11. The apparatus set fort in claim 10 including:
means, in response to a request from the user for an additional profile field, for generating and transmitting a parameter entry input screen suitable for transmission over the communication network to the requesting user.

12. The apparatus set forth in claim 11 including:
means in response to the receipt of a completed parameter entry input screen from the user for updating the stored data defining the control screen associated with the user; and,
means for generating a control screen using the updated stored data and transmitting the updated control screen over the communication system to the user located at the order entry means.

13. The apparatus set forth in any one of claims 10-12 in which the said at lest one profile field includes a plurality of user selectable sub-fields each of which when selected by the user defines a unique action.

14. The apparatus set forth in claim 13 in which the user selectable sub-fields include a first sub-field for requesting an order entry, a second user selectable sub-field requesting an edit of the unique parameters and a third user selectable sub-field requesting deletion of the profile field.

15. The apparatus set forth in claim 14 in which the unique parameters in the profile field include a credit card number sub-field, a ship to address sub-field and a bill to address sub-field.

16. In a data entry system which includes a central accounting system, a plurality of user controlled data entry means and a communication system for connecting the data entry means to the central accounting system an apparatus for generating, in response to a request from a user at a data entry means, a control screen for display at the data entry means including:
a memory;
means for storing in memory screen data for defining a control screen which includes
at least one profile field which includes a plurality of parameters unique to the user, and
a field for indicating, when selected by the user, the need to create an additional profile field containing different parameters unique to the requesting user; and,
means responsive a request from a user at a data entry means for accessing screen data associated with the requester and generating and transmitting a control screen corresponding to the accessed screen data to the data entry means via the communication system.

17. The apparatus set forth in claim 16 including:
means responsive to a request from the user for an additional profile field, for generating and transmitting a parameter entry input screen suitable for transmission over the communication network to the requesting user.

18. The apparatus set forth in claim 17 including:
means responsive to the receipt of a completed parameter entry input screen from the user for updating the stored data defining the control screen associated with the user; and,
means for generating a control screen using the updated stored data and transmitting the updated control screen over the communication system to the user located at the data entry means.
